(19) United States
(12) Patent Application Publication
(10) Pub. No.: US 2003/0038258 A1
(43) Pub. Date: Feb. 27, 2003

(54) Valve for controlling fluids

(76) Inventors: Wolfgang Stoecklein, Stuttgart (DE); Dietmar Schmieder, Markgroeningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/148,548

(22) PCT Filed: Sep. 28, 2001
(86) PCT No.: PCT/DE01/03716

(30) Foreign Application Priority Data
Oct. 4, 2000 (DE) 1 00 48 933.8

(51) Int. Cl. F16K 31/12

(52) U.S. Cl. 251/57

(57) ABSTRACT

A valve for controlling fluids is provided, having a valve member (3) axially movable in a valve body (5), having a hydraulic chamber (12) acting as a hydraulic booster, and having a filling device (15) to compensate for leakage losses, which device communicates with a high-pressure region (14) and a lowpressure region (13) of the valve and has a throttle body (18). According to the invention, it is provided that the throttle body is movable, as a function of a pressure prevailing in the lowpressure region (13), such that filling of the hydraulic chamber (12) with fluid takes place (FIG. 1).

### Prior Art

The invention is based on a valve for controlling fluids as generically defined by the preamble to claim 1.

In the industry, valves for controlling fluids are known that have a valve member and a hydraulic booster. The hydraulic booster as a rule includes a hydraulic chamber, which is located in a low-pressure region of the valve. To compensate for leakage losses, the hydraulic chamber is refilled by a filling device. To that end, the filling device communicates with a high-pressure region of the valve that supplies the filling device with fluid. In order in the filling process to reduce the high pressure to a system pressure in the hydraulic chamber, the filling device typically has a throttle body.

One such valve for controlling fluids, in particular fuel, in a common rail injector is known from European Patent Disclosure EP 0 477 400 Al. This valve is actuatable via a piezoelectric actuator, and a voltage- dependent deflection or change in length of the actuator is transmitted via a hydraulic chamber, which functions as a hydraulic booster or coupler and tolerance compensation element. The hydraulic chamber, between pistons defining it, of which one piston is embodied with a smaller diameter and is connected to a valve closing member to be triggered and the other piston is embodied with a larger diameter and is connected to the piezoelectric actuator, encloses a common compensation volume. The hydraulic chamber is fastened between the two pistons in such a way that the actuating piston executes a stroke lengthened by the boosting ratio of the piston diameter, when the larger piston is moved a certain distance by the piezoelectric actuator.

The hydraulic chamber in the low-pressure region requires a certain system pressure, which drops because of leakage upon actuation of the valve unless adequate filling with fluid takes place.

In the known valve, the system pressure itself required in the hydraulic chamber is generated. This is achieved in practice by delivering fluid from the high- pressure region of the valve to the low-pressure region. This is often done with the aid of leakage gaps, which are realized by means of leakage or filling pins in the form of throttle bodies.

The (re)filling of the hydraulic chamber should be accomplished in such a way that the pressure in the hydraulic chamber is kept as constant as possible. This is because a drop or increase in the pressure in the hydraulic chamber can adversely affect the hydraulic boosting of the valve. In particular, an increase in the system pressure in the hydraulic chamber is unfavorable, since at a high pressure the positive displacement of hydraulic volume out of the hydraulic chamber via the gaps surrounding the adjoining pistons is correspondingly increased. This can for instance lengthen the refilling time for building up and holding the pressure on the low-pressure region to such an extent, under some circumstances, that for lack of incomplete refilling, if activation of the valve occurs shortly thereafter, a shorter valve stroke will be executed, which can adversely affect the opening performance of the entire valve.

In the filling device of the known valve, throttle bodies are used, in which because of their geometric dimensioning, for instance, a continuous throughput of fluid for refilling the hydraulic chamber is provided. This has the disadvantage that only a leakage quantity calculated in advance or ascertained in experiments will be replaced in the hydraulic chamber. Even in valves of the same generic type, the leakage quantity can vary because of production variations, so for each valve, the leakage quantity has to be determined after manufacture, in order for instance to determine the dimensioning of the throttle body accordingly. This means considerable added expense for the known valves.

Another factor is that in the event of a possible change in the leakage, the system pressure in the known valves cannot be kept constant with the filling device. This has the aforementioned adverse effect on the opening performance of the valves, since in the known filling devices it is not possible to change the filling quantity quickly.

### ADVANTAGES OF THE INVENTION

The valve according to the invention for controlling fluids as defined by the characteristics of the body of claim 1 has the advantage that the filling of the hydraulic chamber is done as a function as a function of the pressure in the low-pressure region, so that in the event of leakage from the hydraulic chamber, causing a pressure drop, the throttle body of the filling device is moved in such a way that a corresponding refilling of the hydraulic chamber with fluid takes place.

In the valve of the invention, a compensation for leakage losses in the hydraulic chamber is achieved in the simplest possible way with the filling device, because any pressure change in the pressure specified in the hydraulic chamber causes a motion of the throttle body and thus in turn causes the appropriate filling of the hydraulic chamber with fluid. Thus with the filling device, a predetermined system pressure in the hydraulic chamber can be set precisely and also automatically.

If the pressure in the low-pressure region or the hydraulic chamber is dropping, the throttle body can be moved into an open position in such a way that fluid from the high-pressure region flows to the hydraulic chamber via at least one connecting conduit, until a predetermined system pressure in the low-pressure region is again achieved and the throttle body of the filling device is again in a position of equilibrium, in which no filling of the hydraulic chamber with fluid takes place.

In an advantageous refinement of the invention, it can be provided that the filling device includes bores of different diameter, in which a final control element, adapted to the diameters of the bores, is disposed axially movably, and in the region of the diameter changes a sealing seat is embodied that cooperates with the final control element. Upon pressure changes, especially in the upper bore, which communicates with the low-pressure region or with the hydraulic chamber, the final control element can be moved correspondingly, so that for instance via a connecting conduit, fluid can reach the hydraulic chamber to compensate for leakage losses.

Another refinement of the invention can provide that two pistons are provided as throttle bodies, which are disposed axially movably in the bores. Upon pressure changes, the pistons are moved such that fluid can flow from the high-pressure region into the low-pressure region, or hydraulic chamber, to compensate for leakage losses.

In the valve of the invention, it is especially advantageous that the leakage losses are relatively slight. This is made possible by making the region subjected to high pressure in the filling device is small. As a result, for the most part the leakage quantity is determined by the pressure difference between the low pressure, that is, the system pressure in the low-pressure region, and the ambient pressure. This leakage is naturally less than in the case of a pressure difference between the high pressure and the ambient pressure. It has been demonstrated that in the embodiment of the valve according to the invention, and in particular of the filling device, a reduction in the leakage quantity of up to 80% is achieved compared to known valves.

Moreover, the valve of the invention is not vulnerable to contamination in the fluid or fuel. Because the filling device is structurally simple in design, the production cost for the valve is also reduced.

Preferably, the bores are provided in the valve body. Naturally the bores and the filling device can also be disposed in other components instead.

Further advantages and advantageous features of the subject of the invention can be learned from the description, drawing and claims.

### DRAWING

A plurality of exemplary embodiments of the valve of the invention are shown in the drawing and will be described in further detail in the ensuing description. Shown are

FIG. 1, a schematic, fragmentary view of a first exemplary embodiment of the invention, showing a fuel injection valve for internal combustion engines in longitudinal section;

FIG. 2, a second exemplary embodiment of the invention, showing a detail of a filling device of the valve of the invention; and

FIG. 3, a schematic, fragmentary view of a third exemplary embodiment of the invention.

### DESCRIPTION OF THE EXEMPLARY EMBODIMENTS

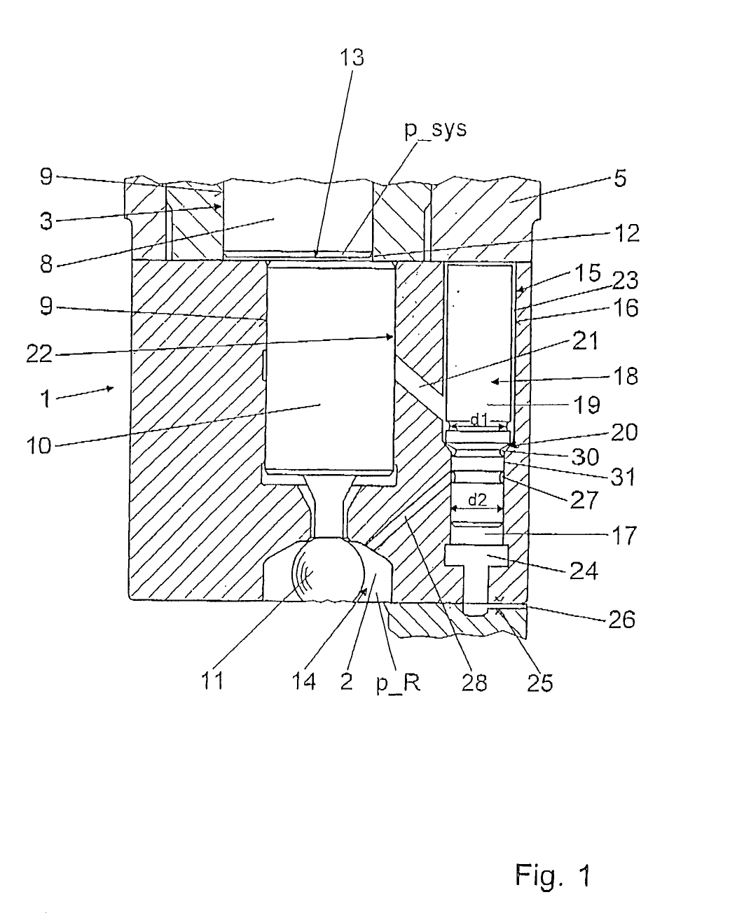

The exemplary embodiments shown in FIGS. 1 through 3 illustrate a use of the valve of the invention in a fuel injection valve 1 for motor vehicle internal combustion engines. In the present versions, the fuel injection valve 1 is embodied as a common rail injector for injecting Diesel fuel, and the fuel injection is controlled by way of the pressure level in a valve chamber 2, which communicates with a supply of high pressure.

For setting an injection onset, injection duration, and injection quantity via force ratios in the fuel injection valve 1, a valve member 3 is triggered via a piezoelectric unit, embodied as a piezoelectric actuator 4, which is disposed on the side of the valve member 3 remote from the valve chamber and from the combustion chamber. The piezoelectric actuator 4 is constructed of multiple layers in the usual way and is braced with an actuator foot, not shown in detail, against a wall of a valve body 5 of the fuel injection valve 1. Via a support plate 7, a first piston 8 of the valve member 3, which is also referred to as a control piston, rests on an actuator head 6.

Besides the first piston 8, the valve member 3, which is disposed axially displaceably in longitudinal bores 9 of the valve body 5, includes a second piston 10, which actuates a valve closing member 11 and is therefore also called the actuating piston.

The pistons 8 and 10 are coupled to one another by means of a hydraulic booster. The hydraulic booster is embodied as a hydraulic chamber 12, which transmits the deflection of the piezoelectric actuator 4 to the valve closing member 11. The hydraulic chamber 12, between the two pistons 8 and 10 defining it, of which the diameter of the second piston 10 is less than the diameter of the first piston 8, encloses a common compensation volume, in which a system pressure p_sys prevails. The hydraulic chamber 12 is fastened between the pistons 8 and 10 in such a way that the second piston 10 of the valve member 3 executes a stroke lengthened by the boosting ratio of the piston diameter, when the larger first piston 8 is moved a certain distance by the piezoelectric actuator 4. The valve member 3, its pistons 8 and 10, and the piezoelectric actuator 4 can be disposed in line on a common axis. In the exemplary embodiments here, the two pistons 8 and 10 are offset from one another.

Via the compensation volume of the hydraulic chamber 12, tolerances resulting from temperature gradients in the component or different coefficients of temperature expansion of the materials used can be compensated for, along with possible settling effects, without thereby causing any change in position of the valve closing member 11 to be triggered.

The ball-like valve closing member 11 cooperates, on the end of the valve member 3 remote from the valve chamber, with valve seats embodied on the valve body 5; the valve closing member 11 divides a low-pressure region 13, having a system pressure p_sys, from a high-pressure region 14 that has a high pressure or rail pressure p_R.

On the high-pressure side, an outlet throttle, not shown, leads in the conventional way to a valve control chamber, in which a movable nozzle needle is disposed. By axial motions of the nozzle needle in the valve control chamber, which chamber communicates in the usual way with an injection line which communicates with a high-pressure storage chamber common to a plurality of fuel injection valves (that is, a common rail) and supplies an injection nozzle with fuel, the injection performance of the fuel valve 1 is controlled.

To compensate for leakage losses in the low-pressure region 13 upon actuation of the fuel injection valve 1, a filling device 15 is provided, which discharges on the low-pressure side into the hydraulic chamber 12.

In FIG. 1, the filling device 15 has a conduitlike hollow chamber in the valve body 5; the hollow chamber is formed by a first, upper bore 16 and an adjoining second, lower bore 17. The diameter of the first or upper bore 16 is greater than the diameter of the second or lower bore 17. In the bores 16, 17, a throttle body 18 adapted to the different diameters is disposed axially movably. In the first exemplary embodiment, the throttle body 18 is embodied as a valve final control element 19, which essentially has one diameter dl in the region of the upper bore 16 and essentially another diameter d2 in the region of the lower bore 17. In the region of the change in diameter between the upper bore 16 and the lower bore 17, a sealing seat 20 is provided between the wall of the bores 16, 17 and the valve final control element 19. The sealing seat 20 cooperates with the valve final control element 19 in such a way that upon actuation of the valve final control element 19 by corresponding pressure changes in the bores 16, 17, the valve final control element 19 is movable into either an open or a closed position.

The diameter dl of the valve final control element 19 is somewhat less than the diameter of the upper bore 16, forming a gaplike low-pressure chamber 23 in the upper bore 16. The lowpressure chamber 23 communicates via the connecting conduit 21 with a gap 22, which here surrounds the actuating piston 10 and communicates with the hydraulic chamber 12.

From the lower bore 17, a further connecting conduit 28 leads to the valve chamber 2, which can be made to communicate with the high-pressure region 14. A leakage collection chamber 24 is embodied on the lower end of the lower bore 17 and has an outlet 26 equipped with a throttle 25.

In the region of the smaller diameter d2, the valve final control element 19 has an annular groove 27, which simultaneously forms an orifice region of the connecting conduit 28 that communicates with the high- pressure region 14. Thus fluid from the high-pressure region 14, which is at rail pressure p_R, can reach the annular groove 27 in the lower bore 17.

In the region of the sealing seat 20, an annular chamber 30 is provided, formed between the wall of the bores 16, 17 and the valve final control element 19. The fuel that is at rail pressure p_R can reach the annular chamber 30, which here acts as a high-pressure chamber, via a gap 31 from the annular groove 27. The gap 31 serves to filter the Diesel fuel, so that any dirt that may be present in the Diesel fuel cannot reach the annular chamber 30.

Thus in an open position, for instance, fluid or fuel from the lower bore 17 communicating with the high-pressure region 14 can first flow into the low-pressure chamber 23 and then, through the connecting conduit 21, it can reach the gap 22 communicating with the hydraulic chamber 12, thus compensating for corresponding leakage from the hydraulic chamber 12.

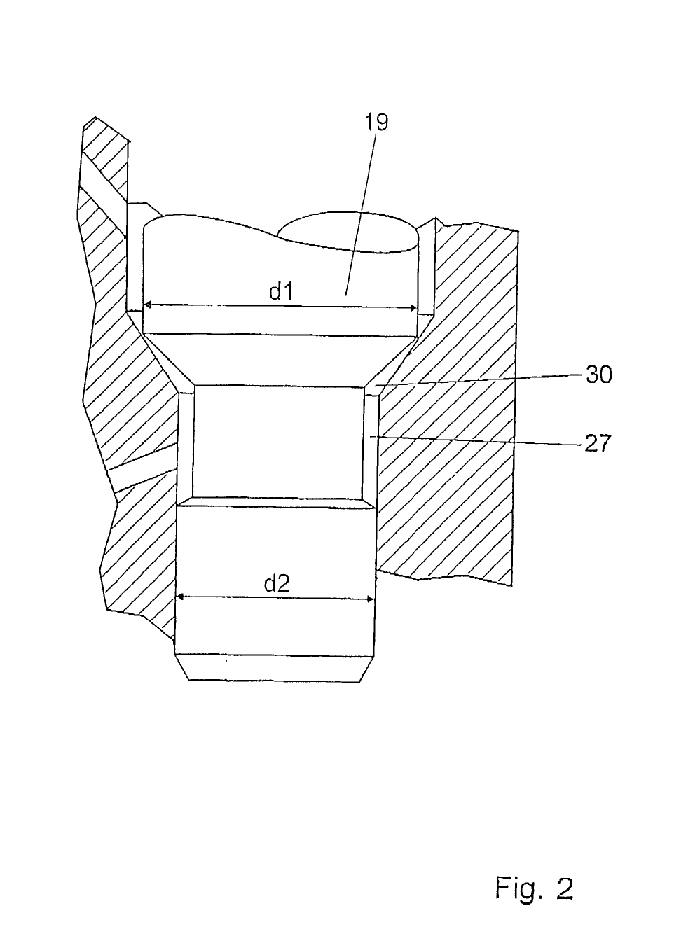

In FIG. 2, a further exemplary embodiment of the invention is shown; for the sake of simplicity, the same reference numerals as before are used for components with the same function. In this exemplary embodiment, the throttle body 18 is once again embodied as a valve final control element 19. However, in this exemplary embodiment the annular groove 27 and annular chamber 30 are dimensioned such that they form one common chamber between the valve final control element 19 and the wall of the bores 16, 17; that is, in this exemplary embodiment, a gap 31 that cleans the fuel is not provided.

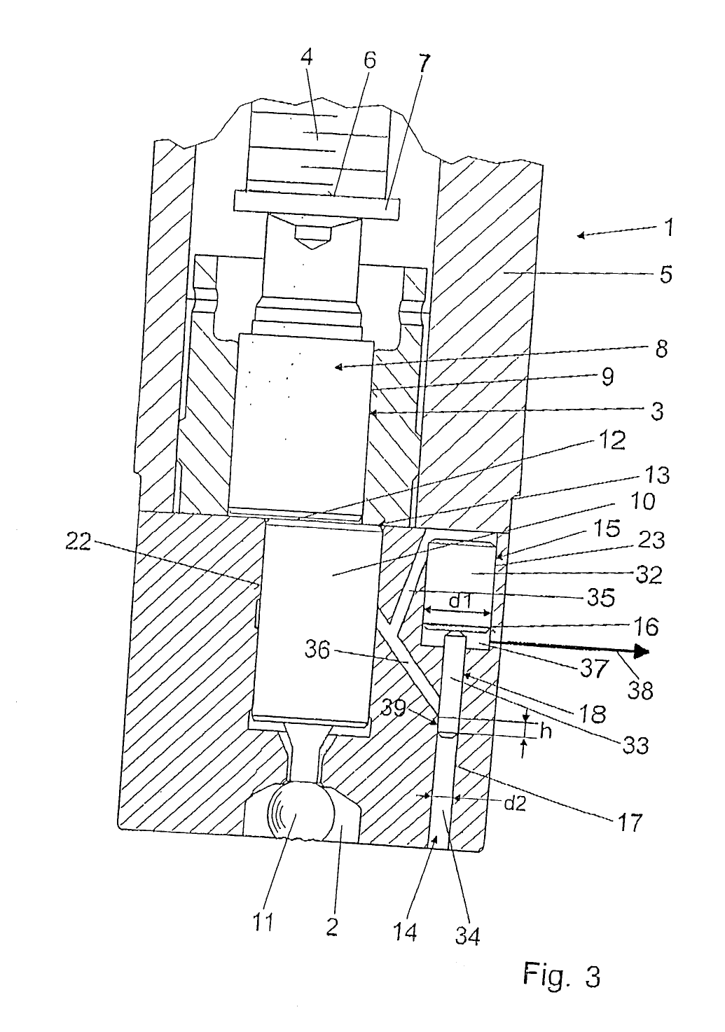

In FIG. 3, a third exemplary embodiment of the invention is shown, in which the throttle body 18 has a first, upper piston 32 and a second, lower piston 33. The diameter dl of the upper piston 32 is approximately equal to the diameter of the upper bore 16. The diameter d2 of the lower piston 33 is approximately equal to the diameter of the lower bore 17. The pistons 32, 33 are disposed axially movably in the bores 16, 17. In the lower bore 17, below the lower piston 33, a high-pressure chamber 34 subjected to rail pressure p_R is provided, which communicates with the high-pressure region 14 or the valve chamber 2.

Above the upper piston 32 in the upper bore 16, a low-pressure chamber 23 is provided, which communicates via connecting conduits 35, 36 with the gap 22, which in turn communicates with the hydraulic chamber 12.

In the upper bore 16, a leakage collection chamber 37 is provided, which is defined by the two pistons 32, 33. The leakage collection chamber 37 has an outlet, indicated by an arrow 38.

The connecting conduit 36 discharges into the lower bore 17, specifically into a leakage gap 39 formed between the wall of the lower bore 17 and the lower piston 33. The length of this gap is determined by the distance between the orifice region of the connecting conduit 36 and the lower end of the piston 33. The length h of the leakage gap 39 can be increased or decreased by corresponding motion of the two pistons 32, 33. Thus the leakage between the high-pressure chamber 34 and the low-pressure chamber 23, which leakage is then intended for filling the hydraulic chamber 12, can also be set.

The fuel injection valve 1 functions as follows; among the various exemplary embodiments, only the filling of the hydraulic chamber 12 differs.

If no voltage is applied to the piezoelectric actuator 4, the valve closing member 11 is located on the valve seat assigned to it, and it is pressed against the valve seat for instance by a spring, not shown, and by the rail pressure p_R in the valve chamber 2 or in the high- pressure region 14.

If the valve is to be opened and an injection by the fuel injection valve 1 is to take place, the piezoelectric actuator 4 is subjected to voltage, as a result of which this actuator suddenly expands axially. The piezoelectric actuator 4 is braced against the valve body 5 and builds up an opening pressure in the hydraulic chamber 12, as a result of which the second piston 10 forces the valve closing member from its valve seat into a middle position. In order to move the valve closing member 11, once it has reached a second, lower valve seat, backwards again into a middle position counter to the rail pressure p_R and still achieve fuel injection, the supply of electrical current to the piezoelectric actuator 4 is interrupted. Simultaneously with the return motion of the valve closing member 11, refilling of the hydraulic chamber 12 to the system pressure p_sys takes place via the filling device 15.

In the two exemplary embodiments, shown in FIG. 1 and FIG. 2, the filling of the hydraulic chamber 12 takes place via the connecting conduit 21, which communicates with the lowpressure chamber 23 in the upper bore 16. To that end, the valve final control element 19 is displaced upward out of a position of equilibrium, so that Diesel fuel can flow out of the annular chamber 30, which is subjected to high pressure or rail pressure p_R, into the low-pressure chamber 23 through the sealing seat 20. As soon as the system pressure p_sys is reached in the hydraulic chamber 12, the pressure in the low-pressure chamber 23 will briefly rise and thus move the valve final control element 19 downward, until the position of equilibrium is again attained. This position of equilibrium can be calculated by making the forces acting on the throttle body equal. The forces are the product of the respective prevailing pressure p_sys and p_R and the area of the respective faces acted upon by it of the throttle body 18, in accordance with the following function:

p_sys·(d1)²=p_R·(d1²−d2²).

As soon as this equilibrium no longer prevails, fuel or fluid from the high-pressure chamber 34 and the annular chamber 30 can flow into the low-pressure chamber 23 and the hydraulic chamber 12, respectively.

In the exemplary embodiment of FIG. 2, the filling proceeds on the same principle. However, in this exemplary embodiment no leakage gap 30 is provided, so that here no filtering of the fuel upon filling of the hydraulic chamber 12 takes place.

In the exemplary embodiment of FIG. 3, the filling takes place via the connecting conduit 36. The fuel required for the filling flows out of the high-pressure chamber 34 via the leakage gap 39. As soon as the system pressure p_sys in the hydraulic chamber 12 or in the low- pressure chamber 23 drops, the two pistons 33, 34 are displaced upward, so that the length h of the leakage gap 39 is shortened accordingly and fuel can thus flow via the leakage gap 39 into the low-pressure chamber 23.

Once the filling is concluded, that is, the system pressure p_sys in the low-pressure chamber 23 or in the hydraulic chamber 12 is attained, the pressure in the low-pressure chamber 23 is increased further, so that the pistons 33, 34 are displaced downward again and thus increase the length h of the leakage gap 39 again, until the throttle body 18 comprising the two pistons 33, 34 is in the position of equilibrium. The position of equilibrium is again obtained by making the relevant areas of the faces of the throttle body that are subjected to the pressures p_sys and p_R equal to one another, in accordance with the following equation:

p_sys·d1²=p_R·d2².

In the position of equilibrium, in all the exemplary embodiments, no filling occurs; that is, system pressure p_sys prevails in the hydraulic chamber 12 or the low-pressure chamber 23, and the high-pressure chamber 34 is subjected to the rail pressure p_R. Since the faces acted upon by the pressures p_sys and p_R are suitably dimensioned, in the position of equilibrium the two pistons 32, 33 cannot be moved.

The embodiments described each pertain to a so-called double-seat valve, but it is understood that the invention can also be employed in single-switching valves with only a single valve seat.

The invention can also be employed not only in the common rail injectors described here as a preferred area of use but also in other fields, such as in pumps, where a low-pressure region is to be separated from a high-pressure region.

1. A valve for controlling fluids, having a valve member (3) axially movable in a valve body (5), having a hydraulic chamber (12) acting as a hydraulic booster, and having a filling device (15) to compensate for leakage losses, which device communicates with a high-pressure region (14) and a low-pressure region (13) of the valve and has a throttle body (18), characterized in that the throttle body is movable, as a function of a pressure prevailing in the low-pressure region (13), such that filling of the hydraulic chamber (12) with fluid takes place.

2. The valve of claim 1, characterized in that the filling device (15) includes at least a first bore (16) and a second bore (17), which have a different diameter, and that by means of pressure changes in the bores (16, 17), the throttle body (18) is disposed axially movably in these bores by means of pressure changes in the bores (16, 17).

3. The valve of claim 2, characterized in that the throttle body (18) is a valve final control element (19), which in the region of the first bore (16) essentially has a larger diameter (dl) and in the region of the second bore (17) essentially has a smaller diameter (d2), and that in the region of the diameter changes in the bores (16, 17), a sealing seat (20) is embodied between the wall of the bores (16, 17) and the valve final control element (19).

4. The valve of claim 3, characterized in that a connecting conduit (28) discharges into the second bore (17), connecting the second bore (17) to the high-pressure region (14); that in the region of the second bore (17) the diameter of the valve final control element (19) is reduced in at least some portions, forming a high-pressure chamber (30); and that the diameter of the valve final control element (19) in the region of the first bore (16) is reduced at least in some portions, forming a lowpressure chamber (23), which communicates with the hydraulic chamber (12) via a connecting conduit (21); and that the lowpressure chamber (23) can be filled with fluid from the highpressure chamber (34) via the sealing seat (20).

5. The valve of claim 4, characterized in that an annular groove (27), provided in the orifice region of the connecting conduit (28) into the second bore (17), and the annular chamber (30) communicate with one another via a leakage gap (31) surrounding the valve final control element (19) in the second bore (17).

6. The valve of one of claims 3-5, characterized in that a leakage collection chamber (24), which is defined by a lower end of the valve final control element (19), is provided in the second bore (17).

7. The valve of claim 6, characterized in that the leakage collection chamber (24) has an outlet (26), which is equipped with a throttle (26).

8. The valve of claim 2, characterized in that the throttle body (18) has at least a first piston (32) and a second piston (33), and the first piston (32), having a larger diameter, is disposed axially movably in the first bore (16), and the second piston (33), having a smaller diameter, is disposed axially movably in the second bore (17).

9. The valve of claim 8, characterized in that a high- pressure chamber (34) is provided on the end of the second piston (33) remote from the first piston (32), and that a low-pressure chamber (23) is provided on the end of the first piston (32) remote from the second piston (33), which low- pressure chamber communicates with the hydraulic chamber (12) via at least one connecting conduit (35, 36).

10. The valve of claim 9, characterized in that the connecting conduit (36) discharges into the second bore (17), and the piston (33) disposed in the second bore (17) essentially covers the orifice region, and at least one leakage gap (39) exists surrounding the second piston (33) in the bore (17).

11. The valve of claim 10, characterized in that the leakage gap (39) hydraulically connects the high-pressure chamber (34) to the low-pressure chamber (23).

12. The valve of one of claims 8-11,characterized in that a leakage collection chamber (37), which is defined by the two pistons (32, 33) and has an outlet (38), is provided in the first bore (16).

13. The valve of one of claims 1-12, characterized in that a piezoelectric unit (4) is provided for actuating the valve.

14. The valve of one of claims 1-13, characterized by its use as a component of a fuel injection valve (1) for internal combustion engines, in particular of a common rail injector.
